(19) United States
(12) Patent Application Publication
(10) Pub. No.: US 2005/0095954 A1
(43) Pub. Date: May 5, 2005

(54) Method of controlling pests

(75) Inventor: Jose Castillo, Hyattsville, MD (US)

Correspondence Address: Mr.Jose Castillo, 5316 Crittenden Street, Hyattsville, MD, 20781, US

(73) Assignee: Jose Castillo, Hyattsville, MD (US)

(21) Appl. No.: 10/904,024

(22) Filed: Oct. 19, 2004

Related U.S. Application Data
(60) Provisional application No. 60/516,945, filed on Nov. 4, 2003.

(51) Int. Cl. A01K 47/00

(52) U.S. Cl. 449/2

(57) ABSTRACT

The present invention is a method of controlling pests, such as the Varroa mite, tracheal mites, and the small hive beetle, in bee-hives or other desired locations comprising extracting plant essential oils from the Diphysa robinoides and applying an effective amount of the extract as a vapor to a desired area of a bee-hive.

### DESCRIPTION

This application claims the benefit of U.S. Provisional Application No. 60/516,945 filed Nov. 4, 2003. The disclosure of said provisional application is incorporated herein by reference in its entirety.

### BACKGROUND OF THE INVENTION

This invention relates to the control of pests in bee-hives by utilizing the application of an effective amount of a plant extract.

Many pests such as the Varroa mite, tracheal mites, and the small hive beetle afflict honey-bee colonies. There have been various pesticides for controlling these pests; however, due to the adaptation of the pests to these pesticides they are no longer effective. Furthermore, many pesticides have been found that they are not acceptable for human consumption. As such there exists a need for a new pesticide to control the infestation of these pests that does not contaminate the honey.

### SUMMARY OF THE INVENTION

The present invention provides a method for controlling pests by applying an extract from the Diphysa robinoides plant to the bee hive so as to kill Varroa mite and tracheal mite infestations. Further, the extract from the Diphysa robinoides plant attracts the small hive beetle such that a trap may be made to collect and isolate the small hive beetle from the bees for easy disposal.

### DETAILED DESCRIPTION OF THE INVENTION

In a preferred embodiment the pesticide is extracted from the leaves of the Diphysa robinoides plant by utilizing known methods of extracting the plant essential oils and compounds from plants.

It has been found that the following are known active compounds of the Diphysa robinoides plant.
GLABRIDRIN, 4′-0-METHYL:(+):
GLABRIDRIN,PRE: 4′-0-METHYL:(−):
STILBENE,TRANS; 3-3′,-4′-5-5′-PENTA-
DIPHYSOLONE
FERREIRIN
KEVIETONE
LAPACHOL
TANNINS
CHAMAEJASMIN
DIPHYSIN
DIPHYSOLIDONE
SITOSTEROL, BETA
HYDROXY: VITEXIN,ISO:

The pesticide can be use at any time while the brood of bees are being raised, wherein the brood consists of bees in the developing stages from egg to adult bee. The pesticide will work well at brood rearing temperatures. It is harmless for the queen, brood, workers and drones. The pesticide is preferably applied as a vapor though the colony as described bellow, however, it may be dispersed through the colony in any of the various known methods of applying a pesticide to a bee colony. For example, the pesticide can alternatively be applied as a fine mist through the colony. Most preferably, the pesticide is applied to an absorbent cloth such as paper towels or napkins, etc. The cloth is subsequently placed inside of a container so as to prevent spilling or dripping of the pesticide. The container is subsequently perforated and placed in the hive so as to allow the fumes to spread throughout the hive. The container can be installed anywhere in the beehive, but preferably in the middle of the brood chambers, especially during the early Fall and middle Spring. Any other time the pesticide container can be placed under the brood chamber or on top of it. The pesticide container is kept in the hive for a period of at least twenty-one days. This is done in order to have the pesticide applied to the hive for the entire life cycle of the mites.

Furthermore, the pesticide has been found to attract the small hive beetle. As such, the container may be placed in a location such that the fumes are spread throughout the hive while attracting the small hive beetle to a trap and therefore isolating it from the bee hive.

As described above this pesticide is 100% organic and tests have shown that it poses no threat to human consumption in the long term. This is an advantage over prior art pesticides since they utilize chemicals that can be harmful to humans.

This pesticide can also be utilized to kill any small mite infestation, wherein small is meant as anywhere from the size of the tracheal mite to the Varroa mite. Such mites are known to exist on humans, animals, in clothing, etc. It is within the scope of this invention to apply this pesticide to any such area to kill mites in this range.

As will be apparent to those skilled in the art in light of the foregoing disclosure, many alterations and modifications are possible in the practice of this invention with out departing from the spirit or scope thereof. Accordingly, the scope of the invention is to be construed in accordance with the substance defined by the following claims.

1. A method for controlling pests, comprising:
applying an effective amount of an extract from the Diphysa robinoides plant or a mixture comprising at least one active compounds of said extract to a desired area.

2. The method of claim 1, wherein said desired area is an insect colony.

3. The method of claim 2, wherein said extract or mixture is applied to said insect colony for at least a period of the life cycle of the pest.

4. The method of claim 3, wherein said period is at least 21 days.

5. The method of claim 3, wherein said pest is the Varroa mite, tracheal mite, or small hive beetle.

6. The method of claim 2, wherein said insect is a bee.

7. The method of claim 2, wherein the extract or mixture is applied to said insect colony during early Fall or early Spring.

8. The method of claim 2, wherein the extract or mixture is applied as a vapor throughout said insect colony.

9. The method of claim 2, wherein the extract or mixture is applied as a liquid to an absorbent material.

10. The method of claim 9, wherein said absorbent material is placed inside a porous container in the brood chamber.

11. The method of claim 9, wherein said absorbent material is place inside a porous container inside said insect colony.

12. The method of claim 1, wherein said extract or mixture comprises at least one of the following:
GLABRIDRIN, 4′-0-METHY:(+):
GLABRIDRIN, PRE: 4′-0-METHY:(+):
STILBENE, TRANS; 3-3′,-4′-5-5′-PENTA-
DIPHYSOLONE
FERREIRIN
KEVIETONE
LAPACHOL
TANNIS
CHAMAEJASMIN
DIPHYSIN
DIPHYSOLIDONE
SITOSTEROL, BETA and
HYDROXY: VIITEXIN,ISO:

13. The method of claim 1, wherein said extract or mixture attracts a first insect to said desired area.

14. The method of claim 13, wherein said first insect is attracted to said area in order to isolate it from a second insect.

15. The method of claim 13, wherein said first insect is a small hive beetle.

16. The method of claim 14, wherein said second insect is a bee.

17. The method of claim 1, wherein said desired area is on a human, animal, or on clothing.
